(19) United States
(12) Patent Application Publication
(10) Pub. No.: US 2010/0121660 A1
(43) Pub. Date: May 13, 2010

(54) Architecture and system for displaying schedule and route information

(76) Inventor: John Boykin, Belmont, CA (US)

Correspondence Address: James A. Gavney JR.;JAG Patent Services LLC, Suite 21, 1901 Old Middlefield Way, Mountain View, CA, 94043, US

(21) Appl. No.: 12/291,712

(22) Filed: Nov. 13, 2008

(51) Int. Cl. G06F 3/048; G06Q 10/00

(52) U.S. Cl. 705/5; 715/772

(57) ABSTRACT

An architecture and system generating interactive web-based flight schedule displays is disclosed. In accordance with the embodiments of the invention the interactive web-based flight schedule graphically displays flight schedules using modules that include flight bars positioned along a time-line grid to graphically represent a duration time, a departure time and arrival time of a corresponding scheduled flight. The modules also may include functionalized end points on the flight bars that designate a departure location and an arrival location of the corresponding flight and one or more stop boxes where necessary to indicate a stop-over. The interactive web-based flight schedule displays include any number to function links and controls that allow a viewer to obtain detailed flight information and/or organize flights according to a selectable criteria before purchasing a flight.

### RELATED APPLICATION

This Application claims priority under 35 U.S.C. §119(e) from the U.S. Provisional Patent Application Ser. No. 60/002,933, filed on Nov. 14, 2007 and titled “A VISUAL WAY TO DISPLAY SCHEDULE AND ROUTE INFORMATION FOR AIRLINE FLIGHT ONLINE.” The co-pending U.S. Provisional Patent Application Ser. No. 60/002,933, filed on Nov. 14, 2007 and titled “A VISUAL WAY TO DISPLAY SCHEDULE AND ROUTE INFORMATION FOR AIRLINE FLIGHT ONLINE” is hereby incorporated by reference.

### FIELD OF THE INVENTION

This invention relates to architectures, systems and methods for providing graphical representations of information. More particularly, the present invention is directed to architectures, systems and methods for providing graphical representations of schedule and route information of airline flights, buses and trains.

### BACKGROUND OF THE INVENTION

Information where there are multiple choices or events that take place can be challenging to display and/or organize in such a way that viewing the information and making a selection or choice from the displayed and/or organized information is easy and intuitive. This is particularly true for scheduling information, where there are multiple events or transportation choices that occur within a given time period, such as in the case with flight scheduled information.

Picking an airline flight online is hard work. Current flight-oriented web sites all do a mediocre job of displaying flight information. There are three basic steps in all flight-shopping web sites: 1) Using search controls (users specifying when they want to fly, origin city, destination city, etc.); 2) Studying flight information (airlines, fares, schedules, etc.); and 3) Purchasing a ticket (entering credit card information, name, address, etc.) Current on-line fare providers display scheduling and route information for airline flights with little or no graphical representation. A number of providers display both outbound and inbound flights of a round trip as a package, while others offer them in separate steps. Showing both outbound and inbound flights makes it even more difficult to compare one outbound flight with another outbound flight and one inbound with another inbound.

Accordingly there is a need to provide an architecture and system for graphically displaying and organizing flight scheduling and routes information in such a way that the information allows a user to select one or more flights from a large number of flights without becoming confused and with minimal effort.

### SUMMARY OF THE INVENTION

The present invention is directed to an architecture and system for and method of generating flight schedule displays. The system is preferably configured to generate accessible interactive web pages for remote server running a graphical user interface. The web pages are accessible over the internet using any suitable internet enabled display device including, but not limited to, a personal computer and a cellular phones. The accessible interactive web pages graphically display flight schedules using modules that correspond to scheduled flights. The modules preferably each include a flight bar positioned along a time-line grid to graphically represent a duration time, a departure time and arrival time of a corresponding scheduled flight.

In further embodiments of the invention the flight bars include functionalized end points that designate a departure location and an arrival location of the corresponding flight. The functionalized end points are selectable function links that access pop-up boxes and/or subweb pages to provide detailed information about scheduled flights and/or airports are encoded to indicate which of the scheduled flights accept frequent flyer miles and or encode models that represent scheduled flight that are co-branded.

The modules of the present invention include one or more stop boxes where necessary to indicate a stop-over. Preferably the stop boxes have lengths representative of a duration of time corresponding to a stopover and are encoded to indicate plane changes and/or indicate an airport where the stopover occurs.

In accordance with the embodiments of the invention the modules, accessible interactive web pages and or schedule displays include one or more selectable function links that access pop-up boxes and/or subweb pages to provide detailed information about scheduled flights, airports, stop-overs and or allow a viewer to purchase a scheduled flight. In yet further embodiments of the invention modules, accessible interactive web pages and schedule displays include a function link or control that allows a viewer to organize flight modules according to a criterion, such as modules corresponding to scheduled flights that have been selected and/or highlighted, modules corresponding to flights with similar fares and modules corresponding to flights with similar or the same arrival and/or departure airport or times. Function links in accordance with the embodiments of the invention correspond to locations of the accessible interactive web pages and or schedule displays where the functionalized end points and/or the stop boxes and/or any other suitable location on the accessible interactive web pages and or schedule displays.

In accordance with the method of the present invention a flight is selected accessing a flight-based web site via the internet and entering one or more preferred flight criteria. An accessible interactive web page and/or schedule display is generated using a graphical user interface on a remote server, which is viewable and accessible on a suitable internet enabled device, such as described previously. The web page and/or schedule display includes a set of flights that match the one or more preferred flight criteria. The flights within the set of flights are graphically represented by flight modules with flight bars, functionalized end points and stop boxes and the flight modules are positioned along a time-line grid, such as described above and below. A viewer then purchases a selected flight from the set of flights using a purchase function link. Prior to purchasing the selected flight the viewer can organize the flights by highlighting or bookmarking flights and selecting an organize function link or control. The viewer can also organize flights by entering additional criteria and selecting an organize function link. The system then displays flights in a sequence determined by the specified criteria.

### BRIEF DESCRIPTION OF THE DRAWINGS

FIGS. 1A-E show computer generated displays 100, 110, 120, 130 of flight schedule information by a number of flight oriented web-sites.

FIGS. 2A-B show portions of flight bars with functionalized end points, in accordance with the embodiments of the invention.

FIG. 2C shows a display with a time-line grid and with flight bars superimposed thereon, in accordance with the embodiment of the present invention.

FIG. 2D shows a module with a flight bar, functionalized ends points, function links and a stop box, in accordance with the embodiments of the invention.

FIG. 2E shows a display with a number of scheduled flights graphically represented by modules superimposed on a time-line grid, in accordance with the embodiments of the invention.

FIG. 2F shows a display with a number of scheduled flights graphically represented by modules with flight bars superimposed on multiple time zone time-line grid, wherein the flight bars include functionalized end points that graphically represent a number of arrival and departure airports corresponding to the scheduled flights, in accordance with the embodiments of the invention.

FIG. 3A shows a display with a number of scheduled flights graphically represented by modules with flight bars superimposed on multiple time zone time-line grid with the time zones displayed below the flight bars in accordance with further embodiments of the invention.

FIG. 3B shows graphical representation of a plurality of widely separated time zones on a time-line grid used in schedule displays, in accordance with further embodiments of the invention.

FIG. 3C shows a display with a number of scheduled flights graphically represented by modules superimposed on time-line grid and with a detail pop-up widow opened by an action such as selecting a details function link from a module, clicking the module or leaving the pointer hovering over the module for a certain amount of time, in accordance with the embodiments of the invention.

FIG. 3D shows a display with a number of scheduled flights graphically represented by modules superimposed on time-line grid with a number of modules highlighted or bookmarked, in accordance with the embodiments of the invention.

FIG. 4 shows a schematic representation of a system with a server configured to run a graphical user interface for generating displays with scheduled flights graphically represented by modules superimposed on time-line grid and function links, which are accessible with an internet enabled device, in accordance with the embodiments of the invention.

FIG. 5 shows a block-flow diagram outline steps for booking flights, in accordance with the method of the present invention.

### DETAILED DESCRIPTION OF THE INVENTION

The present invention is directed to an architecture and system for displaying and organizing schedule information. Schedule information herein refers to both locations and times that events are scheduled to occur and/or transportation vessels are scheduled to depart and arrive. While the present invention is particularly well suited for graphically displaying flight scheduling information, it will be clear to one skilled in the art that the architecture and system of the present invention is equally well suited for displaying schedule information for any number of situations where multiple options or events occur simultaneously within a time frame. For example, the present invention is also suitable for graphically displaying and organizing bus and train schedules.

For the purpose of this specification, the following terms have been ascribed the following meanings:

1) Flight means a complete one-way travel from the user's desired departure point (e.g., San Francisco) to the user's desired arrival point (e.g., New York), including any stopovers along the way (e.g., Chicago). The air travel from, in this example, San Francisco to Chicago would be one “leg” of the flight to New York. The traveler's return from New York to San Francisco would be treated as a separate flight, even though they are priced as a single round trip.

2) Schedule information means both times of scheduled events, such as arrival and departure and route information, such as locations of the scheduled arrivals and departures including any layover locations and time durations of the layovers.

3) Flight information also means information about one specific flight or about all flights shown, such as price, airline, departure and arrival times, stops, and the number of seats still available for purchase at the price shown. Certain pieces of flight information (times, stops, and durations) are represented graphically in flight bars and stop boxes as well as in textual form. All specific flight information shown in this specification is for illustration purposes only.

4) Function links refers to links or buttons such as “Details” and “Select” offered within the context of flight information, enabling users to perform some functions related to a specific flight such as invoking more-detailed information about that flight or selecting it for purchase.

5) Surface web page means a presentation of Schedule information or flight information that is visible when a user first arrives at the page, as distinct from additional information in the details flyout that is hidden unless and until the user invokes it by means such as selecting a function link.

6) Subweb page is a fly-out, pop-up or web page that is accessed through a function link, such as for example a details flyout web page.

7) Details flyout refers to a small box containing all the details that the web site's business decision-makers choose to offer about each flight. Each module has its own corresponding details flyout to elaborate on the particulars of that flight. It is called a flyout because it is hidden until it appears to fly out from its “parent” module in response to action by the user.

8) Flight bar is a time line superimposed or aligned with a time-line grid, wherein the end points of the flight bar represent the scheduled arrival and departure times on the time line grid and the length of the flight bar represents the duration of the flight.

9) Module refers to a flight bar with any stop box(es), flight information, and function links that form the total surface presentation of information about a single flight. Each module has an associated details flyout that elaborates on the particulars of that flight, even though the details flyout is not visible unless and until the user invokes it. The names of the origin and destination cities typically appear only in the headline introducing the search results, not in a module. In certain cases, a variety of airports (such as JFK, LaGuardia, and Newark) may be identified in the modules. The cohesion of a module makes it simple to sort modules in any sequence the user desires, such as by price, by departure time, by arrival time, by airline, by number of stops, etc. Since a module represents a flight, the terms “flight” and “module” are sometimes used interchangeably in this specification.

10) Stop box means a graphical representation of a flight layover on a flight bar. Each stop box begins at a point corresponding to the time the plane lands at the stopover airport and ends at a point corresponding to the time the plane takes off from the stopover airport. The longer the duration of the stopover, the longer the stop box (proportionate to the time-line). There is one stop box for each stopover on a flight (if any). This specification uses the terms “stop” and “stopover” interchangeably.

The present invention is directed primarily to displaying and organizing flight information. The architecture and system of the present invention provides computer generated graphical representation of the time aspects of airline flights and stopovers on a time-line (flight information). The flight scheduled information is preferably accessed via a flight-oriented web site and can be viewed and manipulated by using any number of controls that are viewable on a computer monitor or on the screen of the Web-enabled mobile devices such as a cell phone. While the surface web pages and subweb pages of the present invention are preferably interactive and configured to be dynamically manipulated through, for example, function links and other web enabled functions, the present invention can also be used to display Schedule information statically on, for example, an electronic billboard.

The Figures used herein are provided for illustrative purposes only in compliance with the rules according to 37 CFR 1.84(a). Typically, the graphical displays of the present invention will be displayed on a computer screen and in color. Accordingly, any number of the features and art work shown in the Figs. provided herein can be modified with color, forms, symbols and indicia to graphically provide additional information and/or to provide more viewable surfaces and web pages.

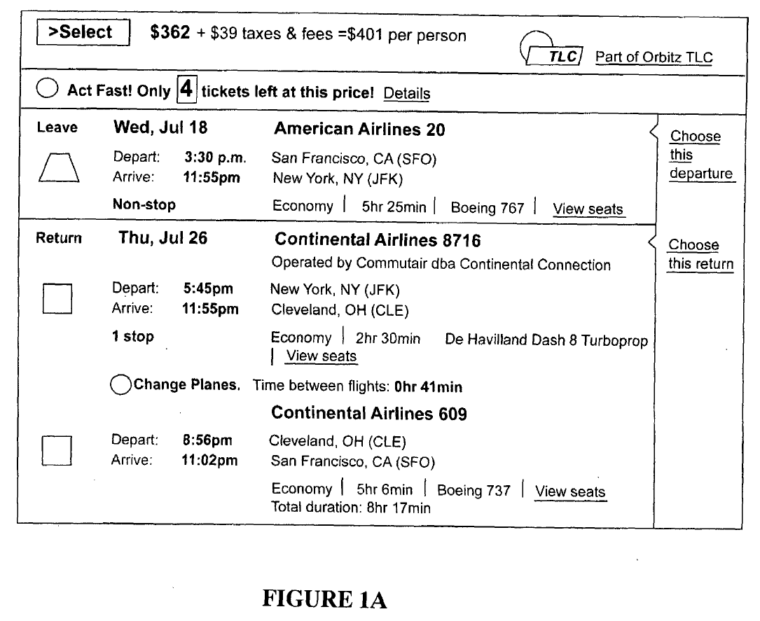

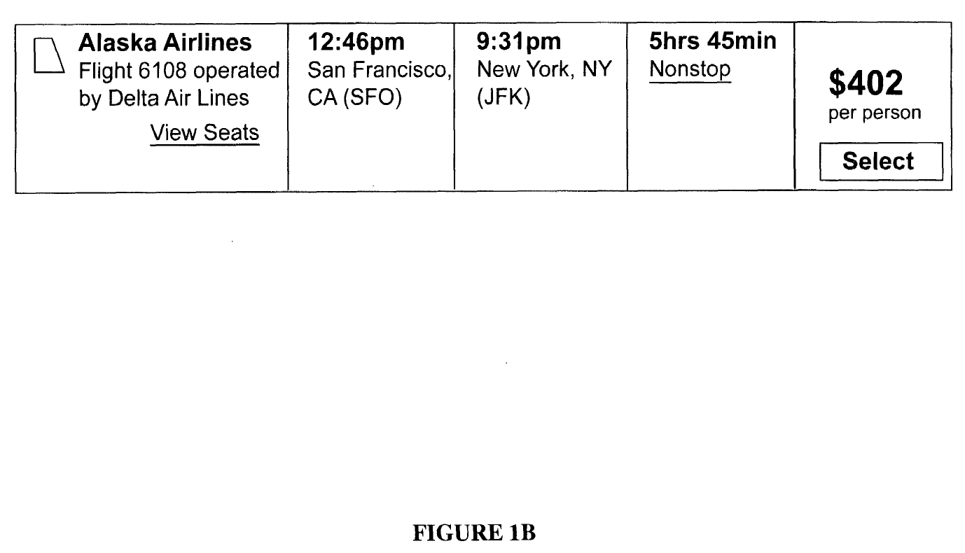

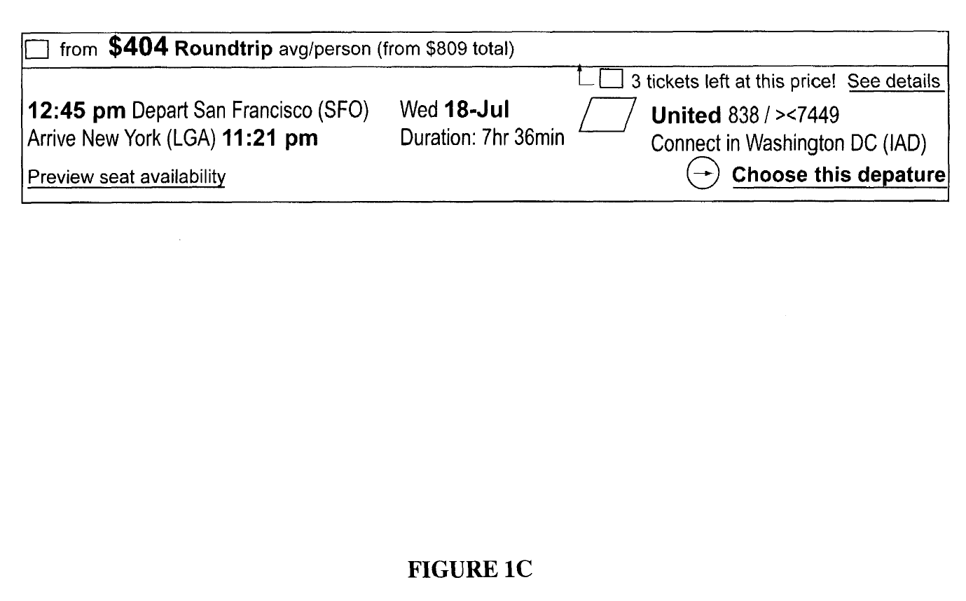

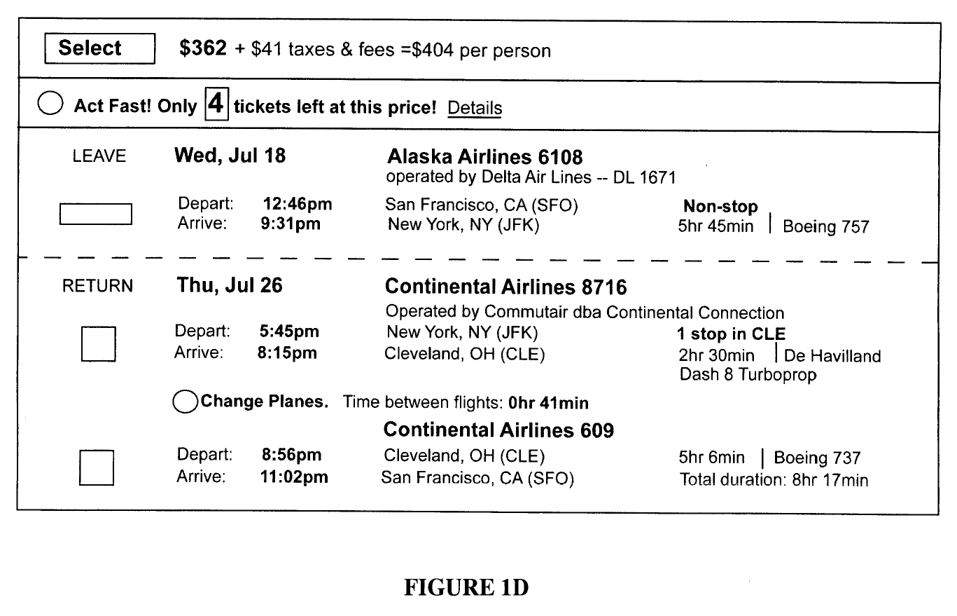

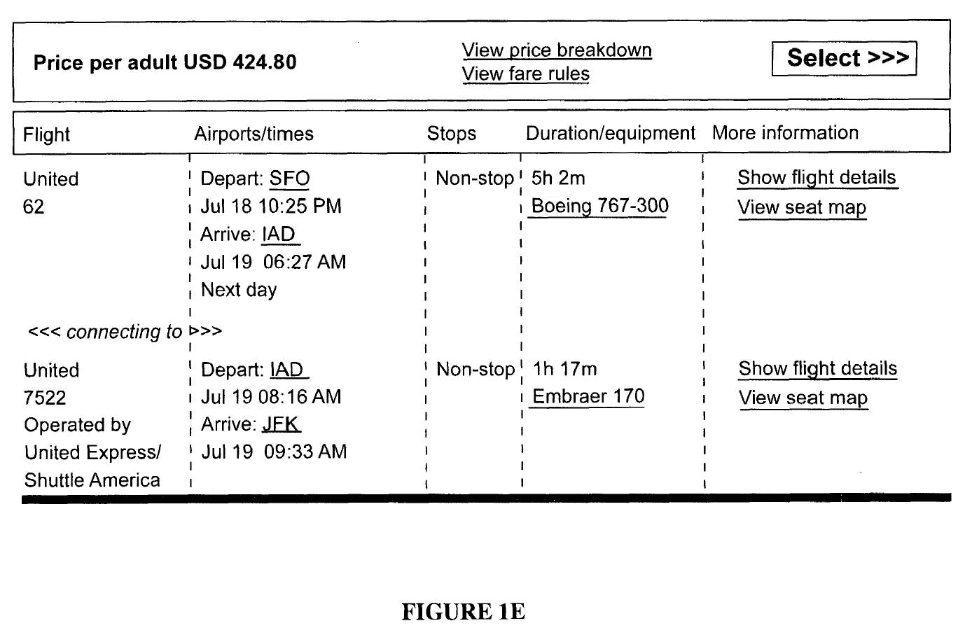

FIGS. 1A-E show typical computer generated displays 100, 110, 120, and 130 of flight scheduling and route information currently used by a number of web based fare providers, which book and sell flights over the internet via a server. All of these computer generated displays include “select” function links that allow a user to select and purchase a flight. While a number of these computer generated displays 100, 110, 120, 130 and 140 show multiple flights, the schedule information is limited and is displayed in a format which makes comparing flight options and selecting flights difficult. Further, these computer generated displays 100, 110, 120 130 and 140 have limited if any features which allow a user to organize multiple flight options for comparison. Also, some of these computer generated displays 100, 110, 120 130 and 140 show both outbound and inbound flights of a round trip as a package, while others offer them in separate steps. Offering both together makes it even more difficult to compare one outbound flight with another outbound flight and one inbound with another inbound. Accordingly, the present invention preferably graphically displays outbound flights and inbound flights of round trips separately. In summary, these computer generated displays 100, 110, 120 130 and 140 are hard to interpret and do not provide a user with flight information in a way that is conducive to making selections or comparisons for alternative flight options. The present invention provides an architecture and system for graphically displaying flight Schedule information, that makes choosing and comparing flight options dramatically easier.

The present invention uses a graphical user interface display that runs on one or more servers. The servers and the user interface display are operable from remote computers or other internet enabled devices. The graphical user interface display is configured to display graphical representations of schedule information in a form of surface web pages and subweb pages. As described previously, the Schedule information is preferably flight Schedule information. The surface web pages and subweb pages include any number of enabling or selectable function links. The function controls allow users to select and organize specific flights and access additional scheduling or other information, such as described in detail below.

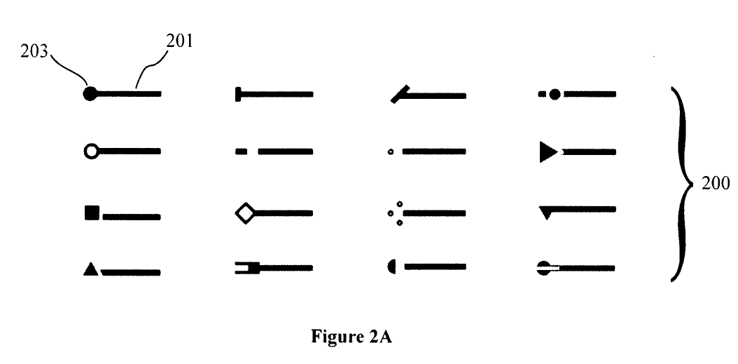

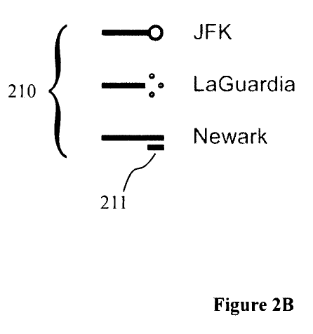

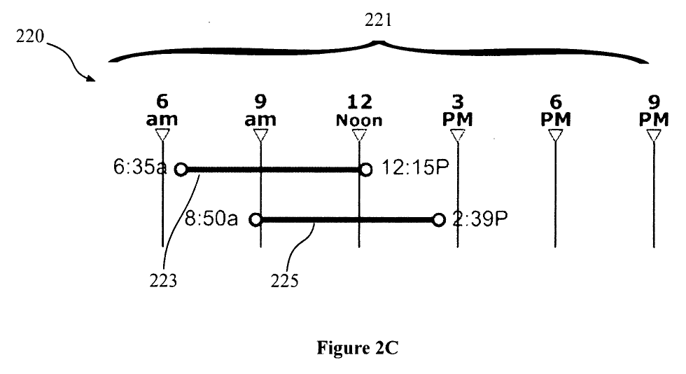

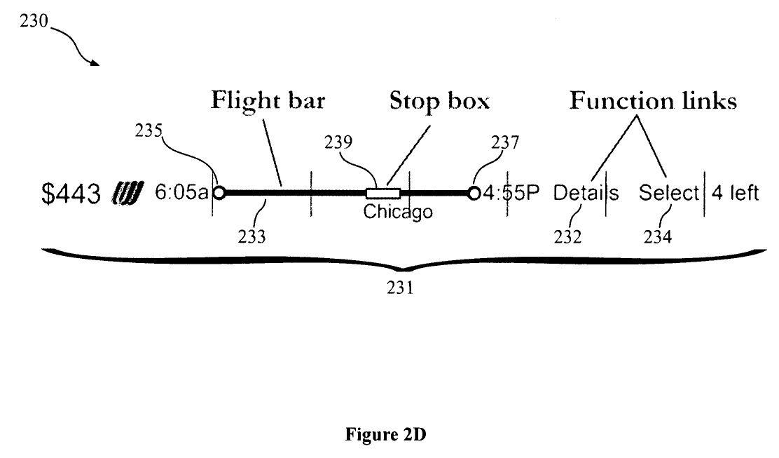

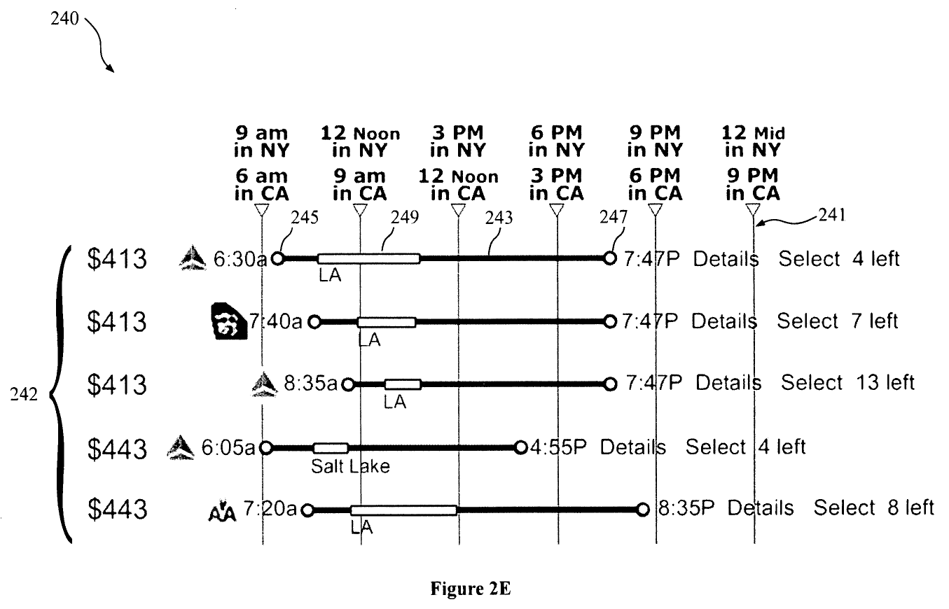

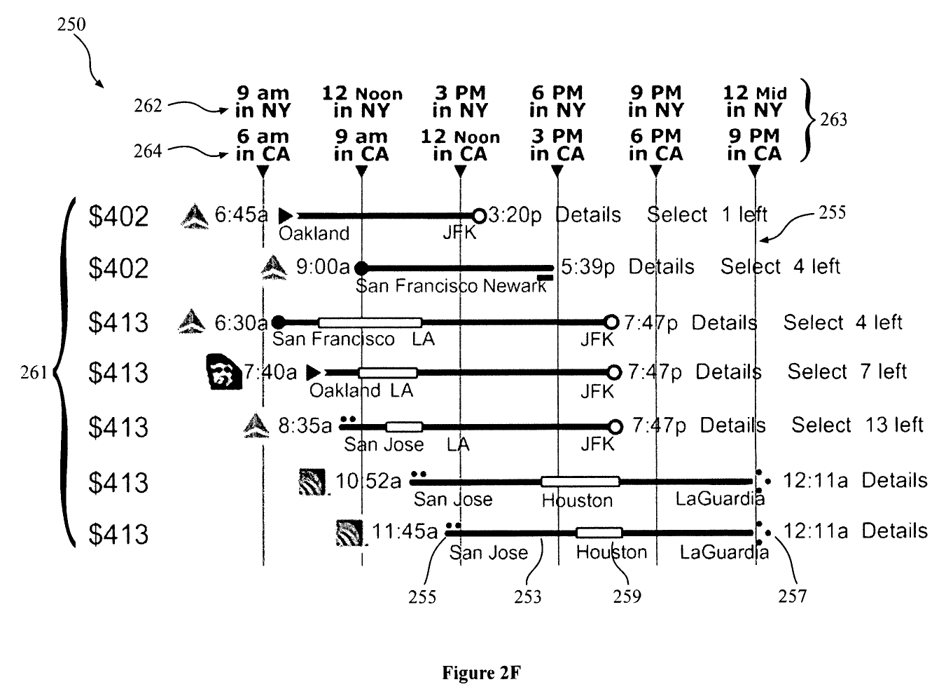

FIGS. 2A-B show sets 200 and 210 of flight bars with functionalized end points, in accordance with the embodiments of the invention. The flight bars of the present invention are used to graphically represent the length of a flight. The flight bars are positioned along a time-line grid with the end points being located at points corresponding to departure and arrival times, thus providing a graphical comparison for flights on a single web-page or subweb page. The end points may consist of art work or symbols that convey additional information or flight information. A portion of a time bar 201 can be a dot end point 203, or any other number of different shapes as shown in the set of portions of time bars 200. In a particular embodiment of the invention the end points are functionalized with symbols that convey the airport corresponding to arrivals and/or departures of the flights corresponding to the flight bars. For example, the end point 211 in the set of time bar portions 210 represent the Newark airport. It should be noted that the name of the airport can also appear near endpoints of the flight bars. While the endpoints of time bars can be functionalized to directly convey information graphically, such as described above, in further embodiments of the invention the end points are function links that are configured to be selected and provide a viewer with additional information about the airport and/or the flight corresponding to the time bar via a subweb page or popup window. Further, where the end points are function links, the system of the invention is configured such that flights can be organized and grouped according to the time bars with the same or similar end points. In accordance with embodiments of the invention, functionalized end points may be encoded to show which flights take the viewer's frequent flyer miles. For example functionalized end points on time bars that represent flights that take the viewer's frequent flyer miles are red in color or otherwise marked to distinguish them from other time bars that represent flights that do not take the viewer's frequent flyer miles.

To carry the example further, a user who just wants to go to Germany and is amenable to flying into any of Germany's many airports may be well served by having a different graphical endpoint for each of those many airports, with or without color coding. If multiple endpoint treatments were used, a key would be highly advisable. If a diversity of endpoints were used to represent different airports, then each airport/city name would be juxtaposed with each endpoint. FIG. 2F for example, is how that might be done to represent all three of the major airports in the San Francisco area and all three major airports in the New York City area.

Regardless of how flight bar endpoints are treated graphically on any given web site, the idea of positioning them to correspond to a specific time on the time-line is intrinsic to this innovation.

FIG. 2C shows a display 220 with a time-line grid 221 and with flight bars 223 and 225 superimposed thereon, in accordance with the embodiment of the present invention. Each flight bar 223 and 225 is placed upon the time-line grid 221, such that the leftmost endpoint corresponds to the flight's departure time from the city of origin and the rightmost endpoint corresponds to the flight arrival time at its ultimate destination. In this example, the flight bar 223 shows that one flight departs at 6:35 a.m. and arrives at 12:15 PM, and the time bar 225 shows that a second flight leaves at 8:50 a.m. and arrives at 2:39 PM.

Even though the endpoints of each flight bar are placed with mathematical precision to correspond to the actual times that they represent, users will be able to perceive from the flight bar itself only an approximation of the time. Despite that perceived imprecision, flight bars are extremely helpful for quick gross comparisons, though not fine enough for making purchasing decisions. So the actual precise times are shown in type immediately adjacent to each endpoint (the departure time in terms of origin city's time zone, and the arrival time in terms of the destination city's time zone; time zones will be discussed in more detail later).

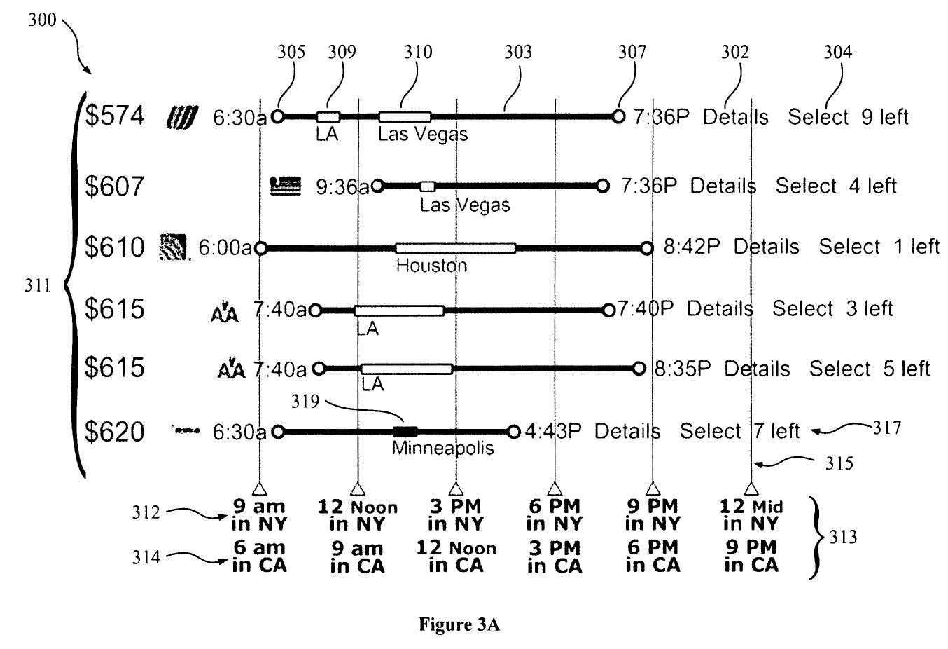

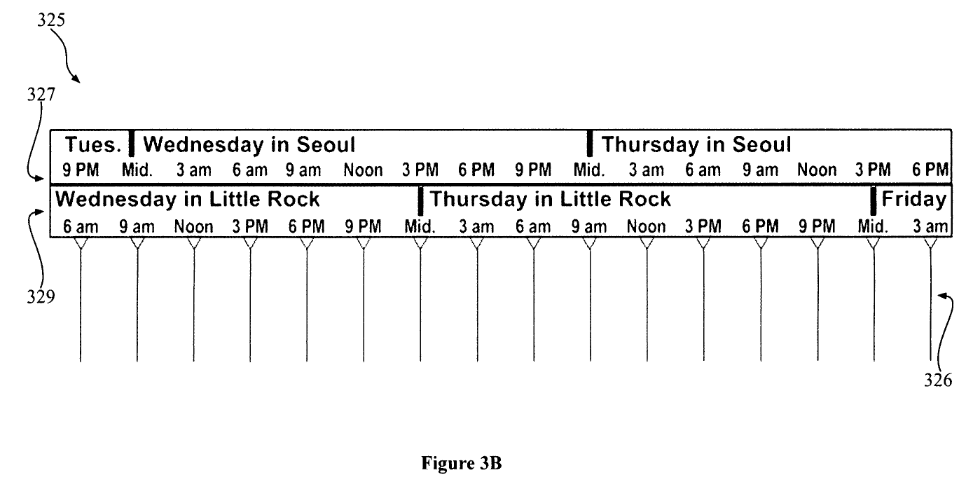

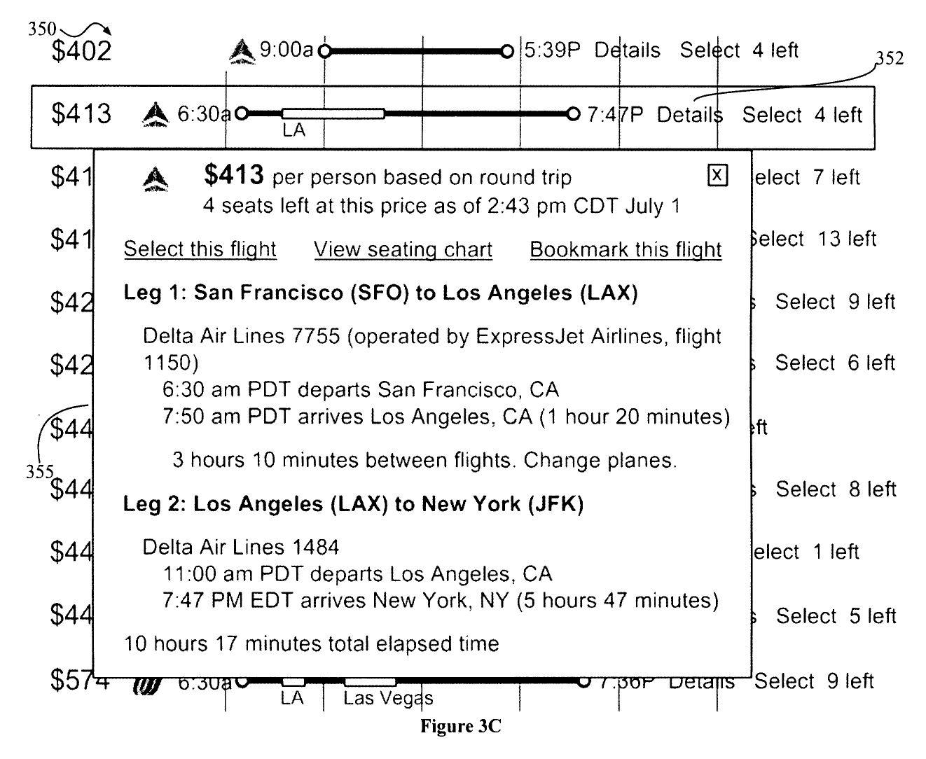

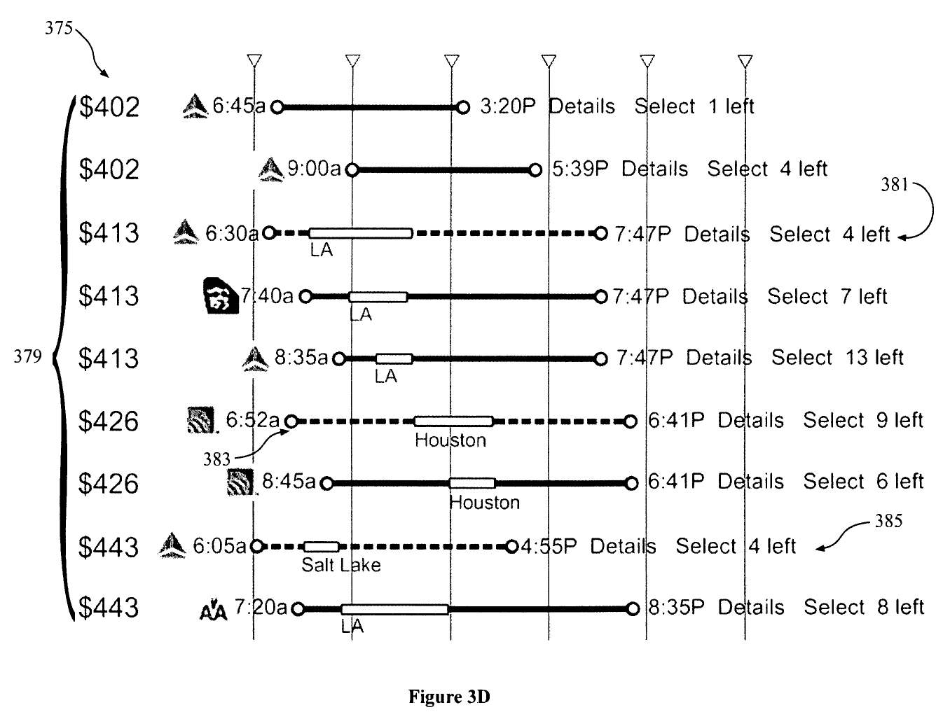

Now referring to FIG. 2D, in preferred embodiment of the invention flight schedules are graphically displayed on a web page in the form of one or more modules. A display 230, for example, includes a module 231 with a flight bar 233 and functionalized end points 235 and 237, such as described above. Preferably the module 231 also include a number of function links, such a details function link 232 and a select function link 234. A viewer can select the details function link to find out more information about a flight schedule, such as described with respect to FIG. 3C below. Using the select function link a viewer can purchase the scheduled flight. In further embodiments of the invention the display 230 also include function controls. For example, the display 230 includes one or more organize function links. Organize function controls allow a viewer to organize modules according to selectable criteria. Suitable selectable criteria include, but are not limited to, modules corresponding to flights that have been selected or highlighted, modules corresponding to flights with similar fares and modules corresponding to flight with similar or the same arrival an/or departure airport or times. In further embodiments of the invention the module 231 is encoded for flights which are co-branded and sold through multiple airlines. For example, modules that represent flights which are co-branded include a prominent and/or colored plus sign next to the Airline logo or any other suitable indicator that distinguishes them from modules that represent flights which are not co-branded.

In accordance with the embodiments of the invention the module 231 also includes a stop box 239, when necessary, for graphically representing a stopover. Most stopovers require passengers to change planes, so those stops are represented in the standard way shown in FIG. 2D. Stops in which passengers do NOT change planes are represented somewhat differently graphically, such as with a light fill color inside the stop box. In this example, a passenger will have a stopover in Chicago and stay on the same plane. Also the length of the stop box preferably graphically indicates a length of time for the stop over. The stop box feature of the present invention is extremely important because it allows the user to glance and see 1) which flights are nonstop and which have one or more stops; 2) which city(ies) each flight goes through; 3) when each stopover begins and ends; 4) how long each stop is; 5) how the duration of one stop compares with the duration of another stop and; 6) which stops entail a change of planes and which do not.

As with flight bars 223 and 225 (FIG. 2C), the left and right edges of each stop box are precisely positioned to represent the times when that stop begins and ends even though the viewer may not perceive that precision. As a result, stop bars can have the effect of indicating approximate information: more or less when the stop begins, more or less when it ends, and more or less how the length of one stop compares with the length of another. Unlike flight bars, though, stop boxes are preferably not accompanied by time numerals on the surface, because specific stopover times are typically less important in flight selection than are flight times. Despite this potential perceived imprecision, stop boxes are very helpful for preliminary flight selection purposes; users who want to know the precise times when a particular flight's stopover begins and ends will get those details from the details flyout (discussed below).

As previously described the functionalized end points 235 and 237 of the time bar 233 in some embodiments of the invention are function links that provide additional airport or flight information. Likewise, the stop box 239 in further embodiments of the invention is a function link, which when selected will provide a viewer with additional information about the stopover or the stopover airport.

FIG. 2E shows a display 240 with a number of scheduled flights graphically represented as modules 242 superimposed on a time-line grid 241. In accordance with this embodiment of the invention the arrival times and departure times are posted next to the functionalized end points 245 and 247 of flight bar 243. Also note that the modules include stop boxes 249 that are labeled with the name of the city where the corresponding stop over occurs and the prices of each of the flights represented the modules 242 are also posted.

A flight originating in one time zone may arrive at a destination in a different time zone. Accordingly, it is preferable to display multiple time zone flights on time-line grids with departure time zones and arrive time zones being strategically positioned below and above each other, respectively. For example, San Francisco's time zone is three hours behind New York's time zone. So the multiple time zone time-line grid shows the New York time line, the arrival time zone, directly above its equivalent San Francisco time line, the departure time zone. In other words the origin time is preferentially on the bottom and the destination time is preferentially on top. To reinforce the distinction its is also preferentially that the origin time line appears in a different color from destination time line.

FIG. 2F shows a display 250 with a number of scheduled flights graphically represented by modules 261 with flight bars 253 superimposed on multiple time zone time-line grid 255. In this example, the times corresponding to the New York time zone are posted along the row 262 and times corresponding to the California time zone are posted along the row 264 on the head portion 263 of the display 250. The flight bars 253 include functionalized end points 255 and 257 that graphically represent arrival and departure airports corresponding to the scheduled flights, such as described with reference to FIG. 2B above. The modules 261 include stop boxes 259 that are labeled with the name of the city where the corresponding stopover occurs and the prices of each of the flights represented the modules 261 are also posted. Note that the names of the arrival and departures airport are also listed. On the right hand side of the display are select function link and details function links. The select function link allows a viewer to select or purchase a flight. The details function link allows a viewer to view flight details, such as shown in FIG. 3C and described below. Function links of the present invention can be labeled with any suitable alternative wording to indicate the purpose of the Function like. For example, a select Function link can be labeled as buy or purchase.

FIG. 3A shows a display 300 with a number of scheduled flights graphically represented by modules 311. As previously described the modules include flight bars 303 with functionalized end points 305 and 307 and stop boxes 309 and 310 stop superimposed on multiple time zone time-line grid 315. In this example, the times corresponding to the New York time zone are posted along the row 312 and times corresponding to the California time zone are posted along the row 314 on a footer portion 313 of the display 300. Prices of each of the flights represented by the modules 311 are also posted on the left hand side of the display 300 and select function links 304 and details function links 302 are located on the right hand side of the display 300. Names of cities or airports corresponding to departures of flights, arrivals of flights and stopovers of flights can also be listed. On the right hand side of the display are select function links and details function links. Also listed on the right hand side of the display are a number of seats still available for flights corresponding to each module. The stop box 319 corresponding to the module 317 is shaded indicating that there is no plane change during the stopover in Minneapolis. The other stop boxes of the modules 311 are hollow indicating that there are plane changes required for these stopovers.

International time zone differences traditionally have been very tricky for travelers to calculate (leaving them wondering, for example, whether Seoul, South Korea, is a day ahead of or a day behind Little Rock, Ark.). To eliminate the additional confusion introduced by changes of day on flights involving widely separated time zones, the time line in FIG. 3b adds some additional elements, including but not limited to 1) a notation of the day of the week in each time zone; 2) a graphic separator between one day and the next in each time zone and; 3) further use of color to clearly differentiate one set of time zone information from the other set of time zone information (not shown).

FIG. 3B shows a graphical representation 325 of a multiple time zone time-line grid 326 used in schedule displays, such as the displays described above and below, in accordance with further embodiments of the invention. In this example multiple time zone time-line grid 326 is used to show times of flights on the time line 329 from Little Rock, Ark. and on the time line 327 to Seoul, South Korea. This example shows the utility of the present invention to simultaneously represent times lines from two radically different time zones, such as 9 p.m. Wednesday in Seoul directly above 6 a.m. Thursday in Little Rock.

The details flyout is a small box containing all of the details that the web site's business decision-makers choose to offer about each flight. Each module has its own corresponding details flyout to elaborate on the particulars of that flight including, but not limited to: 1) city names and airport codes; 2) which airline is operating which leg of the flight (if different from the airline shown in the module); 3) the elapsed time of each leg and each stop and the total elapsed time for the flight; 4) the beginning and ending times of each stop and 5) whether the fare shown includes taxes and fees, etc. A details flyout can also repeat the flight information that appears in the module. A details flyout will also offer function links pertinent to the flight at hand, such as a link to view the airplane's seating chart, a link to bookmark that flight, and a link to select that flight for purchase. This box of details is revealed in response to action by the user such as clicking the details function link, clicking within a hotspot within the module, or leaving the mouse hovering over the module for a certain amount of time. The details flyout box closes when the user either clicks the close box (in its upper right corner) or opens any other details flyout.

FIG. 3C shows a display 350 with a number of scheduled flights graphically represented by modules superimposed on time-line grid, such as described in details above. In this example a details flyout box 355 is open in response to a viewer clicking the details function link of the module 352, clicking within a hotspot of the module 352, or leaving the mouse hovering over the module 352 for a certain amount of time.

In further embodiments of the invention, a viewer can bookmark or highlight modules corresponding to flights of interest. Bookmarking flights is a way of making some flights visually distinctive from others in order to keep track of them as finalists and identifying final lists possible flights to juxtapose for even easier comparison.

FIG. 3D shows a display 375 with a number of scheduled flights graphically represented by modules 379 superimposed on time-line grid with a number of modules 381, 383 and 385 highlighted or bookmarked, in accordance with the embodiments of the invention. Viewers can bookmark a flight by either double-clicking within a hot spot on the module or clicking the “Bookmark this flight” function link in its details flyout box 355 (FIG. 3C). In operation an instruction prompts the viewer that he or she can double-click any flight to bookmark it. Once a flight has been bookmarked, the flight bars of the modules 381, 383 and 385 correspond to the flight selected are highlighted graphically. The bookmarked module becomes eligible to be juxtaposed with any other bookmarked flights if selecting a sort function control. Once a flight is bookmarked, the bookmark this flight function link in the corresponding details flyout toggles to read “Remove bookmark.” By clicking the remove bookmark link in the details flyout box, or double-clicking the module's hotspot again, the module is unbookmarked and returns to its original appearance. In further embodiments of the invention, modules are sortable according to a viewer criteria, such as modules corresponding to flights with similar fares and modules corresponding to flights with similar or the same arrival and/or departure airport or any other suitable viewer criteria.

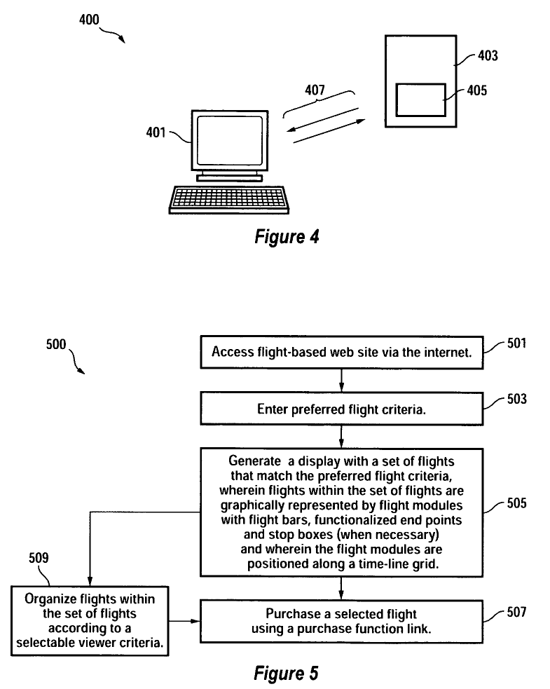

FIG. 4 shows a schematic representation of a system 400 with a server 403 configured to run a graphical user interface 405 for generating displays such as described in details above with reference to FIGS. 3A-D. The graphical user interface program is operable from remote computers 401 or any other internet enabled devices, such as a cell phone, over the internet, as represented by the arrows 407. A viewer can enter information in web pages with the displays and migrate subweb pages, flyouts and/or pop-ups within the displays using any number of data entry activities and/or by enabling selectable function links.

FIG. 5 shows a block-flow diagram 500 outlining steps for booking flights, in accordance with the method of the present invention. In the step 501 a flight-based web site is accessed via the internet. After the flight-based web site is accessed in the step 501, one or more preferred flight criteria is entered in the step 503. The one or more criteria includes, but is not limited to dates of departing or returning flights. After a one or more preferred flight criteria is entered in the step 503, a schedule display is generated using a graphical user interface on a remote server in the step 505. The schedule display is viewable and accessible on a suitable internet enabled device. The web page and/or schedule display includes a set of flights that match the one or more preferred flight criteria entered in the step 503. The flights within the set of flights are graphically represent by flight modules with flight bars, functionalized end points and stop boxes and the flight modules are positioned along a time-line grid. The schedule display is generated in the step 505, a viewer can purchase a selected flight from the set of flights using a purchase function link in the step 507. Prior to purchasing the selected flight in the step 507, in the step 509 the viewer can organize or sort flights by highlighting or bookmarking flights and/or selecting an organize or sort control, such as described above with reference to FIG. 3D.

The present invention has been described in terms of specific embodiments incorporating details to facilitate the understanding of the principles of construction and operation of the invention. As such, references herein to specific embodiments and details thereof are not intended to limit the scope of the claims appended hereto. It will be apparent to those skilled in the art that modifications can be made in the embodiments chosen for illustration without departing from the spirit and scope of the invention.

What is claimed is:

1. An architecture for generating flight schedule displays that include modules superimposed on a time-line, wherein each of the modules include a flight bar with functionalized end points and wherein a length of the flight bar is representative of a duration of a corresponding flight and wherein positions of the functionalized end points on the time-line grid are representative of a departure and arrival times of the corresponding flight.

2. The architecture of claim 1, wherein at least a portion of the modules may include one or more stop boxes, wherein the stop boxes have lengths representative of a duration of time corresponding to a stopover.

3. The architecture of claim 2, wherein one or more stop boxes are coded to indicate plane changes.

4. The architecture of claim 2, wherein a stop box is labeled to indicate city where the stopover occurs.

5. The architecture of claim 2, wherein a stop box is a function link that is selectable and allows a viewer to access information about stopover.

6. The architecture of claim 1, wherein the modules include a hot spot and/or one or more selectable function links that access pop-up boxes and/or subweb pages to provide detailed information about scheduled flights and/or to purchase scheduled flights.

7. The architecture of claim 1, wherein a display includes one or more controls that allow a viewer to organize flight modules according to a criteria, wherein the criteria is selected from the group consisting of modules corresponding to scheduled flights that have been selected and/or highlighted, modules corresponding to flights with similar fares, modules corresponding to flights with similar or the same arrival and/or departure airport or times.

8. The architecture of claim 1, wherein the functionalized end points are selectable function links that access pop-up boxes and/or subweb pages to provide detailed information about scheduled flights and/or airports.

9. The architecture of claim 1, wherein the functionalized end points are encoded to indicate which of the scheduled flights accept this user's frequent flyer miles.

10. The architecture of claim 1, wherein flight schedule displays encode modules that represent scheduled flights that are co-branded.

11. A system comprising a remote server configured to run a graphical user interface, wherein the graphical user interface generates web accessible interactive web pages that graphically display flight schedules wherein the flight schedules include a plurality of modules corresponding to scheduled flights, wherein each module includes a flight bar positioned along a time-line grid to graphically represent a duration time, a departure time and arrival time of a corresponding scheduled flight and wherein the flight bar further includes functionalized end points that designate a departure location and an arrival location of the corresponding flight.

12. The system of claim 11, wherein at least a portion of the modules may include one or more stop boxes, wherein the stop boxes have lengths representative of a duration of time corresponding to a stopover.

13. The system of claim 12, wherein one or more stop boxes are encoded to indicate plane changes.

14. The system of claim 12, wherein the stop box is labeled to indicate an airport where the stopover occurs.

15. The system of claim 12, wherein the stop box is a function link that is selectable and allows a viewer to access information about stopover.

16. The system of claim 11, wherein the interactive web pages include one or more selectable function links that access pop-up boxes and/or subweb pages that provide addition information about scheduled flights, allow a viewer to purchase a scheduled flight or organize flight modules according to a viewer criteria.

17. The architecture of claim 1, wherein the functionalized end points are selectable function links that access pop-up boxes and/or subweb pages to provide detailed information about scheduled flights and/or airports.

18. The system of claim 11, wherein the functionalized end points are encoded to indicate which of the scheduled flight accept this user's frequent flyer miles.

19. The system of claim 11, wherein flight schedule displays encode modules that represent scheduled flights that are co-branded.

20. A method of booking a flight, the method comprising:
a) accessing a flight-based web site via the internet;
b) entering one or more preferred flight criteria;
c) generating a display with a set of flights that match one or more preferred flight criteria, wherein flights within the set of flights are graphically represented by flight modules with flight bars, functionalized end points and stop boxes and wherein the flight modules are positioned along a time-line grid; and
d) purchasing a selected flight using a purchase function link.

21. The method of claim 20, further comprising organizing flights within the set of flights according to a selectable viewer criteria prior to purchasing a selected flight using the purchase function link.
